(19) United States
(12) Patent Application Publication
(10) Pub. No.: US 2024/0152963 A1
(43) Pub. Date: May 9, 2024

(54) INFORMATION PROCESSING DEVICE, DATA DISTRIBUTION METHOD, INFORMATION PROCESSING METHOD, AND STORAGE MEDIUM

(71) Applicant: NEC Corporation, Minato-ku, Tokyo (JP)

(72) Inventor: Masafumi OYAMADA, Tokyo (JP)

(73) Assignee: NEC Corporation, Minato-ku, Tokyo (JP)

(21) Appl. No.: 18/281,169

(22) PCT Filed: Mar. 18, 2021
(86) PCT No.: PCT/JP2021/011020

§ 371 Date: Sep. 8, 2023

(51) Int. Cl. G06Q 30/0251; G06Q 30/0217

(52) U.S. Cl. CPC G06Q 30/0256; G06Q 30/0217

(57) ABSTRACT

In order to attain an object of evaluating a value of data of a seller, an information processing apparatus (1) includes: an extending means (21) that extends, with use of published data (40) which is possessed by a seller (S) and which has been published or is scheduled to be published, target data (D1) which is possessed by a buyer (B) and which is a subject to be analyzed; and an estimating means (22) that estimates a degree of value enhancement (46) of a second analysis result (45) relative to with respect to a first analysis result (44), the first analysis result (44) being a result of analyzing the target data having not been extended yet (41), the second analysis result (45) being a result of analyzing the target data having been already extended (43).

### TECHNICAL FIELD

The present invention relates to a technique for evaluating a value of data.

### BACKGROUND ART

If target data possessed by a certain company is analyzed in combination with another data possessed by another company, there is a possibility that an analysis result which provides a quite high use value for a certain user (for example, a person who possesses the target data) may be obtained. In the following description, “another data” that can be combined with the target data to enhance a value of the analysis result of the target data will be referred to as “analysis support data”.

Generally, however, it seems unlikely that companies willingly provide their own data to other companies.

Here, assume a case where data which can be utilized as analysis support data is published data which is already published or which is scheduled to be published. In the case of such data, it seems likely that a company will provide the data to other companies even if the data is its own data.

However, it is considered that various companies possess a huge amount of published data in various forms. Thus, even if the published data is allowed to be utilized as the analysis support data, it is difficult to properly determine a value of the published data.

For example, Patent Literature 1 discloses a data analysis system that classifies data groups relating to webpages, evaluates their recommendation levels for a user, and gives a recommendation to the user.

Non-Patent Literature 1 discloses a method for determining a sales price of a geoinformation product (GIP). According to this method, the sales price is determined in consideration of a cost required for collection, composition, maintenance, and/or the like of source data of the geoinformation product.

### CITATION LIST

### Patent Literature

[Patent Literature 1]
International Publication No. WO 2016/103519

### Non-Patent Literature

[Non-Patent Literature 1]
Frank, A. “PRICE DETERMINATION FOR GEOGRAPHIC DATA.” (1999)

[Non-Patent Literature 2]
“Inga bunseki gijutsu ni tsuite (Regarding causal analysis technique)”, [online], NEC Corporation, [Searched on Mar. 5, 2021], Internet (URL: https://jpn.nec.com/press/202010/images/0201-01-01.pdf)

[Non-Patent Literature 3]
Ding, Rui et al. “QuickInsights: Quick and Automatic Discovery of Insights from Multi-Dimensional Data.” Proceedings of the 2019 International Conference on Management of Data (2019)

### SUMMARY OF INVENTION

### Technical Problem

None of the prior art documents discloses analyzing a value of the published data from the viewpoint of benefit which is to be brought to a buyer. In order to quantitatively evaluate a value of published data of a seller, it is necessary to estimate benefit which is to be brought to a buyer when the published data is utilized in analysis of target data.

An example aspect of the present invention is to provide a technique for evaluating a value of data of a seller by estimating benefit which is to be brought to a buyer when the data is utilized.

### Solution to Problem

An information processing apparatus in accordance with an example aspect of the present invention includes: an extending means that extends, with use of published data which is possessed by at least one seller and which has been already published or is scheduled to be published, target data which is possessed by at least one buyer and which is a subject to be analyzed; and an estimating means that estimates a degree of value enhancement of a second analysis result relative to a first analysis result, the first analysis result being a result of analyzing the target data having not been extended yet, the second analysis result being a result of analyzing the target data having been extended.

A data distribution method in accordance with an example aspect of the present invention includes: at least one processor determining, on a basis of benefit which is to be brought to a buyer when target data which is possessed by the buyer and which is a subject to be analyzed is extended and analyzed with use of published data which is possessed by a seller and which has been already published or is scheduled to be published, a sales price of a service that analyzes the target data having been extended; providing, in exchange for a reward corresponding to the sales price, the buyer with analysis result data which is a result of analyzing the target data having been extended with use of the published data; and paying, in exchange for use of the published data, a reward to the seller, the reward corresponding to a part of the sales price.

An information processing method in accordance with an example aspect of the present invention includes: at least one processor extending, with use of published data which is possessed by a seller and which has been already published or is scheduled to be published, target data which is possessed by a buyer and which is a subject to be analyzed; and at least one processor estimating a degree of value enhancement of a second analysis result relative to a first analysis result, the first analysis result being a result of analyzing the target data having not been extended yet, the second analysis result being a result of analyzing the target data having been extended.

A control program in accordance with an example aspect of the present invention causes a computer to function as: an extending process of extending, with use of published data which is possessed by a seller and which has been already published or is scheduled to be published, target data which is possessed by a buyer and which is a subject to be analyzed; and an estimating process of estimating a degree of value enhancement of a second analysis result relative to a first analysis result, the first analysis result being a result of analyzing the target data having not been extended yet, the second analysis result being a result of analyzing the target data having been extended.

### Advantageous Effects of Invention

In accordance with an example aspect of the present invention, it is possible to evaluate a value of data.

### BRIEF DESCRIPTION OF DRAWINGS

FIG. 1 is a block diagram illustrating a configuration of a main part of an information processing apparatus in accordance with a first example embodiment of the present invention.

FIG. 2 is a flowchart illustrating a flow of a process of an information processing method in accordance with the first example embodiment of the present invention.

FIG. 3 is a view schematically illustrating a configuration of a data distribution system in accordance with a second example embodiment of the present invention.

FIG. 4 is a flowchart illustrating a flow of a data distribution method in accordance with the second example embodiment of the present invention.

FIG. 5 is a block diagram illustrating a configuration of a main part of an information processing apparatus in accordance with a third example embodiment of the present invention.

FIG. 6 is a view illustrating an example of an appraisal request screen.

FIG. 7 is a view illustrating an example of the appraisal result screen.

FIG. 8 is a view illustrating an example of a search request screen.

FIG. 9 is a view illustrating an example of the search result screen.

FIG. 10 is a view illustrating an example of a specific configuration of an extending section of the information processing apparatus in accordance with the third example embodiment of the present invention.

FIG. 11 is a view illustrating an example of a data structure of various data input and output by the extending section.

FIG. 12 is a view illustrating an example of a specific configuration of an estimating section of the information processing apparatus in accordance with the third example embodiment of the present invention.

FIG. 13 is a view illustrating an example of a data structure of data-before-extension in accordance with a variation.

FIG. 14 is a view illustrating an example of a data structure of first causal relation data (first analysis result) output by an analyzing section of the information processing apparatus in accordance with the third example embodiment of the present invention.

FIG. 15 is a view illustrating an example of a data structure of data-after-extension in accordance with a variation.

FIG. 16 is a view illustrating an example of a data structure of second causal relation data (second analysis result) output by the analyzing section of the information processing apparatus in accordance with the third example embodiment of the present invention.

FIG. 17 is a view illustrating an example of a data structure of purchase history information stored in a storage section of the information processing apparatus in accordance with the third example embodiment of the present invention.

FIG. 18 is a sequence diagram illustrating a flow of a process of the information processing method in accordance with the third example embodiment of the present invention.

FIG. 19 is a block diagram illustrating an example of a hardware configuration of each of the information processing apparatuses in accordance with the example embodiments of the present invention.

### DESCRIPTION OF EMBODIMENTS

### First Example Embodiment

The following description will discuss a first example embodiment of the present invention in detail with reference to the drawings. The present example embodiment is a basic form of example embodiments described later.

<Configuration of Information Processing Apparatus>

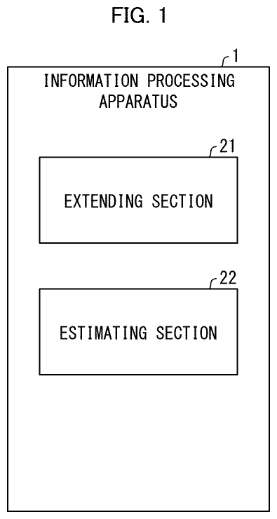

FIG. 1 is a block diagram illustrating a configuration of an information processing apparatus 1 in accordance with the present example embodiment. As shown in FIG. 1, the information processing apparatus 1 includes an extending section 21 and an estimating section 22. In the present example embodiment, the extending section 21 is a configuration realizing an extending means. In the present example embodiment, the estimating section 22 is a configuration realizing an estimating means.

The extending section 21 extends, with use of published data which is possessed by a seller and which has been already published or is scheduled to be published, target data which is possessed by a buyer and which is a subject to be analyzed.

The estimating section 22 estimates a degree of value enhancement of a second analysis result relative to a first analysis result, the first analysis result being a result of analyzing the target data having not been extended yet, the second analysis result being a result of analyzing the target data having been extended.

In the following description, the target data having not been extended yet will be referred to as “data-before-extension”, whereas the target data having been extended will be referred to as “data-after-extension”.

The degree of value enhancement of the second analysis result is an indicator indicating how much the use value and significance of the second analysis result for a buyer who possesses the target data are increased as compared to the first analysis result. The first analysis result is an analysis result obtained as a result of analyzing the data-before-extension in a state as possessed by the buyer, without use of the published data. The second analysis result is an analysis result obtained as a result of analyzing the data-after-extension, which has been extended with use of the published data. That is, the degree of value enhancement indicates benefit for the buyer, specifically, a use value of the seller's published data as analysis support data.

The information processing apparatus 1 may be realized by a computer and a control program. The above control program is a control program causing the computer to function as the extending section 21 and the estimating section 22.

<Flow of Process of Information Processing Method>

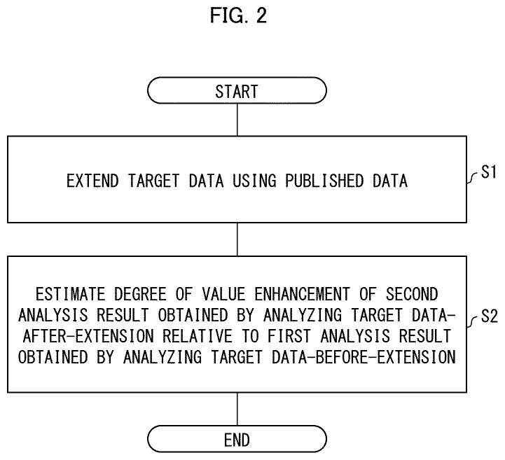

FIG. 2 is a flowchart illustrating a flow of a process of an information processing method in accordance with the present example embodiment. The information processing method is executed by the information processing apparatus 1.

In step S1 (extending process), the extending section 21 extends, with use of published data which is possessed by a seller and which has been already published or is scheduled to be published, target data which is possessed by a buyer and which is a subject to be analyzed.

In step S2 (estimating process), the estimating section 22 estimates a degree of value enhancement of a second analysis result relative to a first analysis result, the first analysis result being a result of analyzing data-before-extension, the second analysis result being a result of analyzing data-after-extension.

As described above, the information processing apparatus 1 in accordance with the present example embodiment employs a configuration including: the extending section 21 that extends, with use of published data which is possessed by a seller and which has been published or is scheduled to be published, target data which is possessed by a buyer and which is a subject to be analyzed; and the estimating section 22 that estimates a degree of value enhancement of a second analysis result relative to a first analysis result, the first analysis result being a result of analyzing the target data having not been extended yet, the second analysis result being a result of analyzing the target data having been already extended.

Further, the information processing method in accordance with the present example embodiment employs a configuration including: at least one processor extending, with use of published data which is possessed by a seller and which has been published or is scheduled to be published, target data which is possessed by a buyer and which is a subject to be analyzed; and at least one processor estimating a degree of value enhancement of a second analysis result relative to a first analysis result, the first analysis result being a result of analyzing the target data having not been extended yet, the second analysis result being a result of analyzing the target data having been already extended.

Therefore, with the information processing apparatus 1 or the information processing method in accordance with the present example embodiment, it is possible to quantitatively estimate, as a degree of value enhancement, benefit which is to be brought to a buyer when published data of a seller is utilized in analysis of target data of the buyer. As a result, it is possible to attain an effect of making it possible to evaluate a value of published data of a seller from the viewpoint of benefit which is to be brought to a buyer.

### Second Example Embodiment

The following description will discuss a second example embodiment of the present invention in detail with reference to the drawings. Note that any constituent element that is identical in function to a constituent element described in the first example embodiment will be given the same reference numeral, and a description thereof will not be repeated.

<Outline of Data Distribution System>

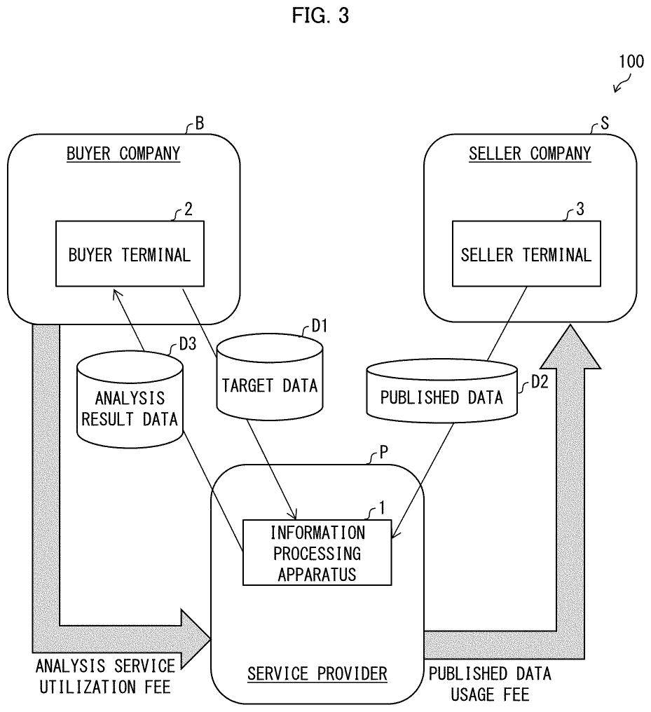

FIG. 3 is a view illustrating an example of a data distribution system 100 to which an information processing apparatus 1 in accordance with the present disclosure is applied.

The data distribution system 100 is a system for distributing published data possessed by a seller. The data distribution system 100 includes at least the information processing apparatus 1 in accordance with the present disclosure.

Entities using the data distribution system 100 include a buyer purchasing published data, a seller selling published data, and a service provider intermediating between the buyer and the seller.

The service provider may be, for example, a service provider P providing an analysis service to a buyer. Specifically, the above-described analysis service provided by the service provider P is a service that (i) analyzes target data D1 possessed by a buyer in combination with published data D2 and (ii) provides, to the buyer, analysis result data D3, which is obtained as a result of the analysis and is more useful for the buyer.

The service provider P possesses the information processing apparatus 1. The information processing apparatus 1 has a function of evaluating a market value of the published data, i.e., appraising the published data, in order that the published data of the seller is distributed in the data distribution system 100.

The information processing apparatus 1 determines a sales price of the above-described analysis service, i.e., a sales price of the published data D2 with use of at least one processor. The information processing apparatus 1 determines the sales price on the basis of benefit which is to be brought to the buyer when the target data D1, which is possessed by the buyer and which is a subject to be analyzed, is extended and analyzed with use of the published data D2, which is possessed by the seller and which has been already published or is scheduled to be published. The information processing apparatus 1 may be, for example, the information processing apparatus 1 in accordance with the first example embodiment or any of information processing apparatuses 1 in accordance with the later-described example embodiments.

The buyer may be, for example, a buyer company B wishing to perform a more advantageous economic activity by utilizing an analysis result obtained by analyzing its own target data D1. The buyer company B may possess a buyer terminal 2 as needed.

The seller may be, for example, a seller company S wishing to increase its profit by selling its own published data D2 to allow someone to utilize the published data D2 as analysis support data. The seller company S may possess a seller terminal 3 as needed.

In exchange for a reward corresponding to the sales price determined by the information processing apparatus 1, the service provider P provides the buyer company B with the analysis result data D3, which is a result of analyzing the target data D1 having been extended with use of the published data D2. For example, as shown in FIG. 3, the reward corresponding to the determined sales price may be paid by the buyer company B to the service provider P as a utilization fee of the analysis service.

Then, in exchange for usage of the published data D2 as the analysis support data, the service provider P pays, to the seller, a reward corresponding to a part of the above-described sales price. For example, as shown in FIG. 3, the reward corresponding to the part of the sales price may be paid by the service provider P to the seller company S as a usage fee of the published data.

The above-described data distribution system 100 provides the following merit. That is, the buyer company B pays the above-described sales price and, in turn, obtains the analysis result data D3, which is more enriched and more useful than an analysis result obtained as a result of analyzing the target data D1 by itself, so that the buyer company B can perform an advantageous economic activity. The sales price is determined on the basis of the benefit expected to be brought to the buyer when the buyer utilizes the published data D2. Therefore, it is considered that the sales price is a reasonable sales price for the buyer company B.

The service provider P determines a reasonable sales price, and can serve as an intermediate between the buyer company B and the seller company S to attain, as benefit, a difference between (i) a utilization fee of the analysis service that the service provider P receives from the buyer company B and (ii) a usage fee of the published data that the service provider P pays to the seller company S.

By allowing the buyer company B to utilize, as analysis support data, published data D2 which is already existing and which has a content that can be published, the seller company S can gain benefit without paying a new cost or leaking secret information to other companies.

As described above, it is possible to construct a market on which published data is distributed as a product.

<Flow of Process of Data Distribution Method>

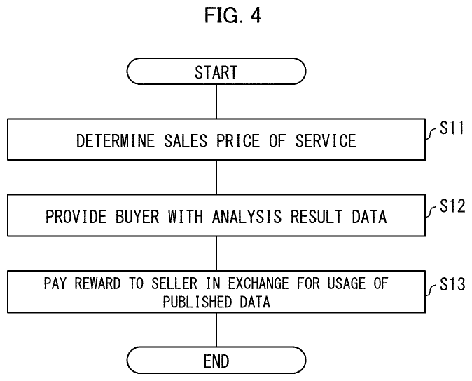

FIG. 4 is a flowchart illustrating a flow of a data distribution method executed in the data distribution method 100. The below-described data distribution method is executed by, for example, at least one processor functioning as the information processing apparatus 1.

In step S11 (sales price determining process), the information processing apparatus 1 determines a sales price of a service that analyzes data-after-extension, the determining being carried out on the basis of benefit which is to be brought to a buyer when target data of the buyer is extended and analyzed with use of published data possessed by a seller. The benefit which is to be brought to the buyer is determined by the information processing apparatus 1 on the basis of the information processing method described in the first example embodiment.

In step S12 (providing process), the information processing apparatus 1 provides, in exchange for a reward corresponding to the sales price thus determined, the buyer company with analysis result data which is a result of analyzing the data-after-extension having been extended with use of the published data.

In step S13 (payment process), the information processing apparatus 1 pays, in exchange for usage of the above-described published data, a reward to the seller, the reward corresponding to a part of the sales price.

As described above, the data distribution method in accordance with the present example embodiment employs a configuration including: at least one processor determining, on the basis of benefit which is to be brought to a buyer when target data which is possessed by the buyer and which is a subject to be analyzed is extended and analyzed with use of published data which is possessed by a seller and which has been already published or is scheduled to be published, a sales price of a service that analyzes the target data having been extended; providing the buyer with analysis result data which is a result of analyzing the target data having been extended with use of the published data, the providing the analysis result data being carried out in exchange for a reward corresponding to the sales price; and paying, to the seller, a reward corresponding to a part of the sales price, the paying the reward being carried out in exchange for usage of the published data.

Therefore, with the data distribution method in accordance with the present example embodiment, in addition to the effect given by the information processing apparatus 1 in accordance with the first example embodiment, an effect of making it possible to construct a market on which published data is distributed as a product.

(Variations of Data Distribution Method)

The delivery of the analysis result data in the above-described S12 may be electronically executed between the information processing apparatus 1 and the buyer terminal 2 or may be physically executed, by another means, between the service provider and the buyer company.

The process in which the service provider receives, from the buyer company, the reward corresponding to the sales price may be executed before or after S12. The delivery of the reward may be electronically executed between the buyer terminal 2 and the information processing apparatus 1 or may be physically executed, by another means, between the buyer company and the service provider.

Assume that the process in which the information processing apparatus 1 obtains the published data of the seller company is executed at any timing before S12. The information processing apparatus 1 may not directly obtain the published data from the seller terminal 3. The information processing apparatus 1 may obtain the published data from another storage apparatus in which published data, which has been already published, is stored.

The payment process in S13 may be executed before or after the process of obtaining the published data. Further, the payment process in S13 may be electronically executed between the information processing apparatus 1 and the seller terminal 3 or may be physically executed, by another means, between the service provider and the seller company.

The published data D2 may be, for example, web page data constituting a website of the seller company S. The seller company S can not only utilize the web page data as an advertisement means but also gain benefit by selling, to the buyer company B, the web page data having a use value as analysis support data. Since the web page data has been already generally published, it seems that the seller company S does not have to take a special risk regarding selling of the web page data to the buyer company B. Furthermore, the seller company S only needs to provide the existing web page data to the service provider P, and thus has a merit of gaining benefit even without paying any additional cost such as a cost required to process the web page data into data for selling.

Note that an analysis tool that the service provider P uses to obtain the analysis result data D3 may be the one owned by the service provider P or the one owned by another company. The service provider P may outsource the analysis process for obtaining the analysis result data D3 to another company. In this case, the information processing apparatus 1 may estimate, for each analysis processor company, a degree of value enhancement of the analysis result data D3. Then, the information processing apparatus 1 may select, as an outsourcing contractor, an analysis processor company who provides an optimum analysis tool or an optimum analysis process. In exchange for reception, from the analysis processor company, the analysis result data D3 which is to be provided to the buyer company B, the service provider P may pay, to the analysis processor company, a part of the utilization fee of the analysis service that the service provider P receives from the buyer company B.

### Third Example Embodiment

The following description will discuss a third example embodiment of the present invention in detail with reference to the drawings. Note that any constituent element that is identical in function to a constituent element described in the foregoing example embodiments will be given the same reference numeral, and a description thereof will not be repeated.

In the present example embodiment, in an example, an information processing apparatus 1 is applied to the data distribution system 100 described in the second example embodiment. That is, the information processing apparatus 1 belongs to a service provider P. Further, the information processing apparatus 1 is communicably connected with, through a communication network such as the Internet, a buyer terminal 2 belonging to a buyer company B and a seller terminal 3 belonging to a seller company S.

In the present example embodiment, the data distribution system 100 can receive, from a user of the data distribution system 100, an instruction to start appraisal of published data of a seller, and can present a result of the appraisal to the user. Further, the data distribution system 100 can receive, from a user, an instruction to search for published data that can enhance a value of an analysis result of target data of a buyer, and can present a result of the search to the user.

The user of the data distribution system 100 can be, for example, an operator who belongs to the service provider P and directly operates the information processing apparatus 1, an operator who belongs to the buyer company B and operates the buyer terminal 2, and/or an operator who belongs to the seller company S and operates the seller terminal 3.

<User Interface>

(Configuration of Information Processing Apparatus)

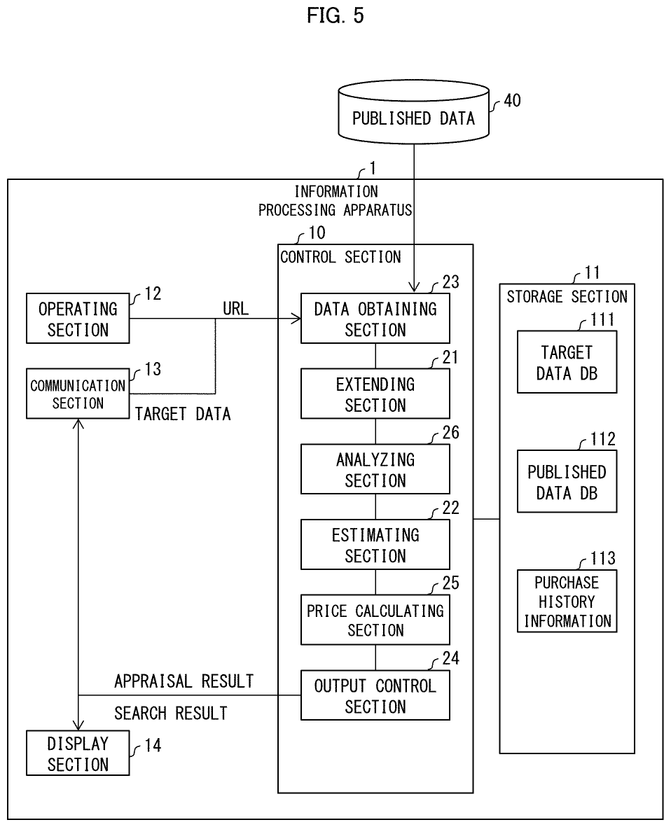

FIG. 5 is a block diagram illustrating a configuration of an information processing apparatus 1 in accordance with the present example embodiment. As shown in FIG. 5, the information processing apparatus 1 includes a control section 10, a storage section 11, an operating section 12, a communication section 13, and a display section 14.

The control section 10 is constituted by, for example, a computing apparatus such as a central processing unit (CPU) or a dedicated processor. Sections of the control section 10 described later with reference to FIG. 5 can be realized by the above-described computing apparatus loading, onto random access memory (RAM) or the like, a program stored in a storage apparatus (e.g., the storage apparatus 11) realized by read only memory (ROM) or the like and executing the program thereon.

In the storage section 11, various data used by the control section 10 is stored. In the present example embodiment, the storage section 11 has a database of target data (hereinafter, referred to as “target data DB 111”) stored therein in a nonvolatile manner. The storage section 11 may have a database of published data (hereinafter, referred to as “published data DB 112”) stored therein in a nonvolatile manner. The storage section 11 may have purchase history information 113 stored therein in a nonvolatile manner. The storage section 11 may be configured as an external storage apparatus that the information processing apparatus 1 can access.

The operating section 12 is an input apparatus that accepts input operation carried out by a user who operates the information processing apparatus 1. The operating section 12 inputs, to the control section 10, an instruction signal corresponding to the input operation having been accepted.

The display section 14 is an output apparatus that presents information processed by the control section 10 to a user of the information processing apparatus 1 in a visible manner. For example, the display section 14 is constituted by, e.g., a liquid crystal display (LCD) or an electro-luminescence (EL) display. For example, the display section 14 may be combined with the operating section 12 to constitute a touch panel.

With the above configuration, the operator who belongs to the service provider P and directly operates the information processing apparatus 1 can carry out various operations as a user of the data distribution system 100 to obtain information from the information processing apparatus 1. There may be a case where the operator who belongs to the service provider P and directly operates the information processing apparatus 1 is absent and the information processing apparatus 1 operates as a server apparatus for a client apparatus such as the buyer terminal 2, the seller terminal 3, and/or the like. In such a case, the operating section 12 and the display section 14 may be omitted as appropriate. Further, in this case, the operator who operates the buyer terminal 2 or the seller terminal 3 can be regarded as a user of the data distribution system 100.

The communication section 13 is a communication apparatus that communicates with another apparatus such as the buyer terminal 2 and/or the seller terminal 3 through a communication network such as the Internet.

For example, the control section 10 may further include, in addition to the extending section 21 and the estimating section 22 explained in the first example embodiment, at least selected from the group consisting of a data obtaining section 23, an output control section 24, a price calculating section 25, and an analyzing section 26.

In the present example embodiment, the data obtaining section 23 is a configuration realizing a data obtaining means. In the present example embodiment, the output control section 24 is a configuration realizing an output control means. In the present example embodiment, the price calculating section 25 is a configuration realizing a price calculating means. In the present example embodiment, the analyzing section 26 is a configuration realizing an analyzing means. For example, the analyzing section 26 may be, as an analyzing means, a configuration realizing a statistical causal discovery means described in, e.g., Non-Patent Literature 2.

In accordance with an input instruction from a user, the data obtaining section 23 obtains data designated by the user. For example, the data obtaining section 23 may obtain published data 40 designated by the user. The published data 40 may be, for example, web page data constituting a website of a seller company S. In this case, the data obtaining section 23 obtains the web page data on the basis of a Uniform Resource Locator (URL) designated by the user.

The output control section 24 respectively outputs, for buyers possessing pieces of target data, degrees of value enhancement of second analysis results obtained from the pieces of target data having been extended with use of the obtained web page data.

In the present example embodiment, a plurality of pieces of target data of a respective plurality of buyer companies B may be registered in the target data DB 111 in advance. The estimating section 22 can respectively estimate, for the pieces of target data of the registered buyer companies B, degrees of value enhancement of second analysis results given on the basis of the web page data obtained in the above-described manner.

The output control section 24 controls each section carrying out output operation so that at least the degrees of value enhancement of the respective pieces of target data of the buyer companies B are presented to the user as an appraisal result of the web page data. For example, the output control section 24 may cause the display section 14 to display the degrees of value enhancement of the respective pieces of target data so as to present the appraisal result to the user of the information processing apparatus 1. For another example, the output control section 24 may transmit, via the communication section 13, the appraisal result to the seller terminal 3, and may cause a display section of the seller terminal 3 to display the appraisal result so as to present the appraisal result to a user of the seller terminal 3.

In another example, the data obtaining section 23 may obtain target data designated by a user. For example, the data obtaining section 23 may obtain, on the basis of a storage part of target data designated by a user, the target data from the storage part, and may register the target data in the target data DB 111. Alternatively, the data obtaining section 23 may receive target data transmitted from the buyer terminal 2, and may register the target data in the target data DB 111. The data obtaining section 23 may read, from the target data DB 111, the target data designated by the user.

The output control section 24 respectively outputs, for sellers possessing pieces of web page data, the degrees of value enhancement of the second analysis results obtained as a result of extending the obtained target data with use of the pieces of web page data.

In the above-described another example, a plurality of pieces of web page data of a respective plurality of seller companies S may be registered in the published data DB 112 in advance. For example, the data obtaining section 23 may periodically browse the websites of the seller companies S with use of a crawler technology or the like, obtain pieces of web page data constituting the websites, and register the pieces of web page data in the published data DB 112. For the target data obtained in the above-described manner, the estimating section 22 can respectively estimate degrees of value enhancement of second analysis results obtained as a result of extending the target data with use of the registered pieces of web page data of the seller companies S.

The output control section 24 controls each section carrying out output operation so that at least the degrees of value enhancement of the respective pieces of web page data of the seller companies S are presented to the user as a search result of the web page data. For example, the output control section 24 may cause the display section 14 to display the degrees of value enhancement obtained by the respective pieces of web page data so as to present the search result to the user of the information processing apparatus 1. For another example, the output control section 24 may transmit, via the communication section 13, the search result to the buyer terminal 2, and may cause a display section of the buyer terminal 2 to display the search result so as to present the search result to a user of the buyer terminal 2.

On the basis of the designated web page data, the estimating section 22 may respectively estimate degrees of value enhancement of all pieces of target data registered in the target data DB 111. Alternatively, the estimating section 22 may respectively estimate degrees of value enhancement of, among the pieces of target data registered in the target data DB 111, some pieces of target data extracted according to a given rule. For example, the estimating section 22 may extract pieces of target data whose similarities to the designated web page data are not less than a given value, and may estimate degrees of value enhancement thereof. A similarity between the web page data and the target data may be determined on the basis of the number of identical keywords among keywords included in the web page data and the target data. The web page data and the target data may include not only text data but also data of any form, such as image data and audio data. For example, a similarly between the web page data and the target data may be determined to be high on the basis of the fact that a content of image data included in the web page data and a keyword included in the target data indicate the same matter.

On the basis of the designated target data, the estimating section 22 may respectively estimate degrees of value enhancement given with all the respective pieces of web page data registered in the published data DB 112. Alternatively, the estimating section 22 may respectively estimate degrees of value enhancement given with, among the pieces of target data registered in the published data DB 112, some pieces of web page data extracted according to a given rule. For example, the estimating section 22 may extract pieces of web page data whose similarities to the designated target data are not less than a given value, and may estimate degrees of value enhancement thereof.

Examples of Screen

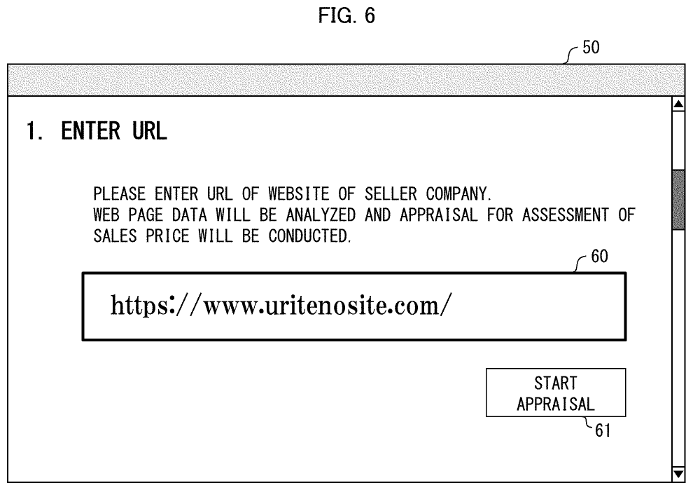

FIG. 6 is a view illustrating an example of an appraisal request screen 50 presented to a user. The output control section 24 generates the appraisal request screen 50, and presents the generated appraisal request screen 50 to the user. The appraisal request screen 50 is a user interface (UI) via which a user carries out, with respect to the information processing apparatus 1, operation for requesting appraisal of published data 40. In order to provide a UI to a user of the service provider P, the output control section 24 may cause the display section 14 of the information processing apparatus 1 to display the appraisal request screen 50. In order to provide a UI to a user of the seller company S, the output control section 24 may communicate with the seller terminal 3 via the communication section 13 to cause the display section of the seller terminal 3 to display the appraisal request screen 50.

In an example, the appraisal request screen 50 may include a region 60 to which a URL of a website including web page data to be appraised is input. For example, an operator of the seller terminal 3 inputs, to the region 60, a URL of a his/her company's website for which he/she wants to know the sales price, and presses a button 61 for giving an instruction to start appraisal. In response to the pressing, the seller terminal 3 transmits, to the information processing apparatus 1, an appraisal request including the URL input to the region 60.

The user operates the appraisal request screen 50 in this manner, so as to give the appraisal request for the web page data to the information processing apparatus 1.

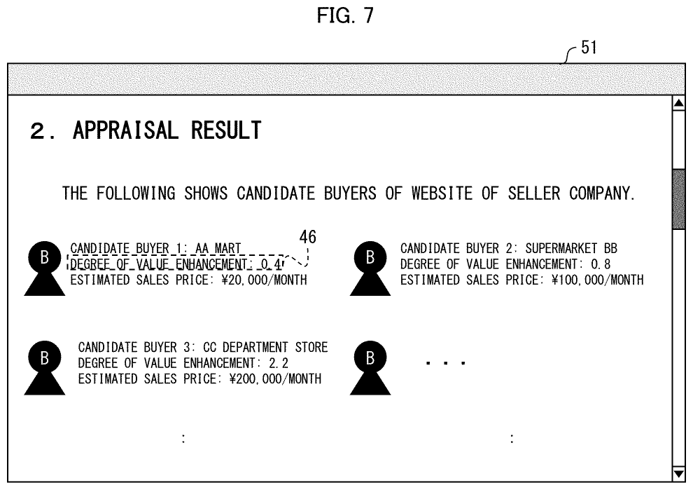

FIG. 7 is a view illustrating an example of an appraisal result screen 51 presented to a user. The output control section 24 generates the appraisal result screen 51, and presents the generated appraisal result screen 51 to the user. The appraisal result screen 51 is a UI via which information relating to an appraisal result is provided to the user. The output control section 24 may cause the display section 14 of the information processing apparatus 1 to display the appraisal result screen 51 or may cause the display section of the seller terminal 3 to display the appraisal result screen 51.

For example, in the appraisal result screen 51, degrees of value enhancement 46 estimated by the estimating section 22 may be sorted according to the buyer companies B and arranged in the sorted manner. Together with the degrees of value enhancement 46, sales prices calculated on the basis of the degrees of value enhancement 46 may be displayed.

In this manner, the user can know candidate buyers of the web page data via the appraisal result screen 51. Further, on the basis of the degrees of value enhancement 46 or the sales prices displayed together with the candidate buyers, the user can know a market value of the web page data.

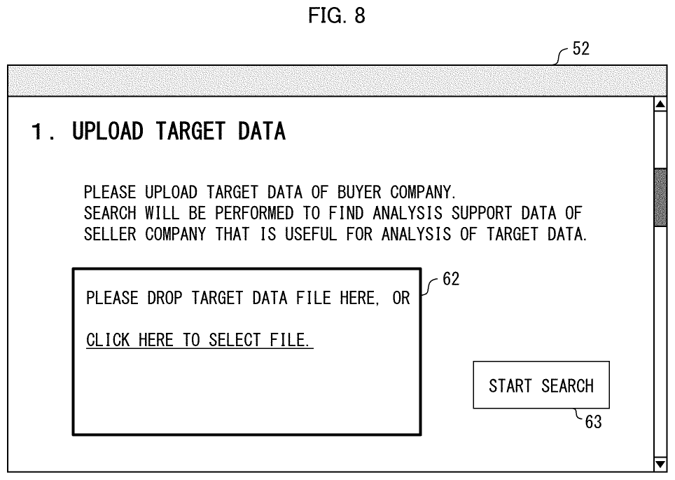

FIG. 8 is a view illustrating an example of a search request screen 52 presented to a user. The output control section 24 generates the search request screen 52, and presents the generated search request screen 52 to the user. The search request screen 52 is a UI via which the user carries out, with respect to the information processing apparatus 1, operation for requesting search for published data 40 that can be used for analysis in combination with target data. The output control section 24 may cause the display section 14 of the information processing apparatus 1 to display the search request screen 52 or may cause the display section of the seller terminal 3 to display the search request screen 52.

In an example, the search request screen 52 may include a region 62 to which information designating target data which is a subject to be analyzed is input. For example, an operator of the buyer terminal 2 drags and drops the target data which is a subject to be analyzed on the region 62, and presses a button 63 for giving an instruction to start searching. In response to the pressing, the buyer terminal 2 transmits, to the information processing apparatus 1, a search request including the target data dropped on the region 62. In a case where the target data is registered in the information processing apparatus 1 in advance, the region 62 may be a region to which identification information for identifying the target data or the buyer company B who is an entity requesting the search is to be inputted. On the basis of the identification information included in the search request, the information processing apparatus 1 can read, from the target data DB 111, the target data of the buyer company B who is the requesting entity.

In this manner, the user can operate the search request screen 52 to send, to the information processing apparatus 1, a search request for published data 40 which can be combined with the target data.

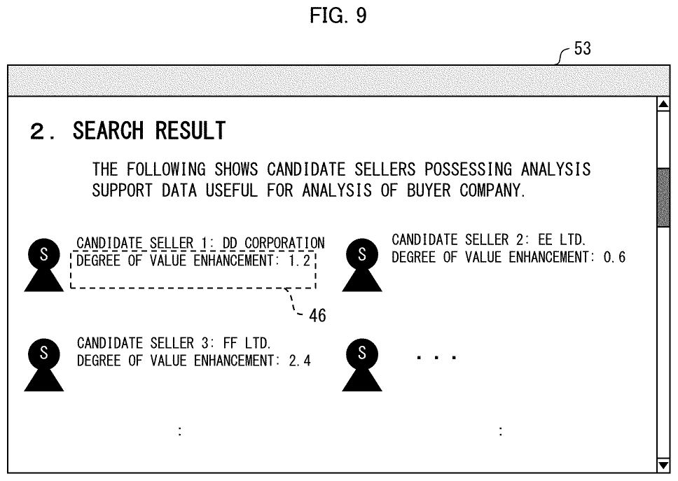

FIG. 9 is a view illustrating an example of a search request screen 53 presented to a user. The output control section 24 generates the search result screen 53, and presents the generated search result screen 53 to the user. The search result screen 53 is a UI via which information relating to a search result is provided to the user. The output control section 24 may cause the display section 14 of the information processing apparatus 1 to display the search result screen 53 or may cause the display section of the buyer terminal 2 to display the search result screen 53.

For example, in the search result screen 53, degrees of value enhancement 46 estimated by the estimating section 22 may be sorted according to the seller companies S and arranged in the sorted manner. Together with the degrees of value enhancement 46, sales prices calculated on the basis of the degrees of value enhancement 46 may be displayed (not illustrated).

In this manner, the user can know, via the search result screen 53, candidate buyers of the published data 40 combined with the target data. Further, on the basis of the degrees of value enhancement 46 displayed together with the candidate sellers, the user can quantitatively acknowledge degrees of merit brought to a buyer when the target data is combined with the respective pieces of published data 40.

(Variations of Data Display Method)

In at least one of the appraisal result screen 51 shown in FIG. 7 and the search result screen 53 shown in FIG. 9, the output control section 24 may execute the following display method.

For example, the output control section 24 may display a list of candidate buyer companies B or a list of candidate seller companies S in such a manner that the candidates are indicated in a descending order of similarities between pieces of target data and pieces of published data of the buyer companies B and the seller companies S matched with each other. As described above, the similarity may be determined on the basis of a frequency, a percentage, and/or the like at which texts, images, sounds, and/or the like indicating the same matters are included in the target data and the published data.

Alternatively, for example, the output control section 24 may display a list of candidate buyer companies B or a list of candidate seller companies S in a descending order of degrees of value enhancement estimated for the respective candidates.

Alternatively, for example, the output control section 24 may display a list of candidate buyer companies B or a list of candidate seller companies S in a descending order of sales prices calculated of the respective candidates.

Further alternatively, for example, the output control section 24 may display a list of candidate buyer companies B in a descending order of price at which the candidate purchased published data or in a descending order of the number of times that the candidate purchased published data.

Still further alternatively, for example, the output control section 24 may display a list of candidate seller companies S in a descending order of price at which published data of the candidate was sold in the past or in a descending order of the number of times that the published data was sold.

As described above, the information processing apparatus 1 in accordance with the present example embodiment employs a configuration further including: the data obtaining section 23 that obtains the web page data on the basis of a URL designated by the user; and the output control section 24 that outputs, for each of the buyers who possess the target data, the degree of value enhancement of the second analysis result obtained from the target data having been extended with use of the obtained web page data.

Further, the information processing apparatus 1 in accordance with the present example embodiment employs a configuration further including: the data obtaining section 23 that obtains the target data designated by the user, and the output control section 24 that outputs, for each of the sellers who possess the web page data, the degree of value enhancement of the second analysis result obtained by extending the obtained target data with use of the web page data.

Therefore, with the information processing apparatus 1 in accordance with the present example embodiment, it is possible to attain, in addition to the effects given by the information processing apparatuses 1 in accordance with the foregoing example embodiments, an effect of making it possible to provide a user with excellent operability in inputting an instruction to the information processing apparatus 1. Further, it is possible to attain an effect of making it possible to provide the user with excellent visibility when the user obtains information from the information processing apparatus 1.

<Extension of Target Data>

(Configuration of Extending Section 21)

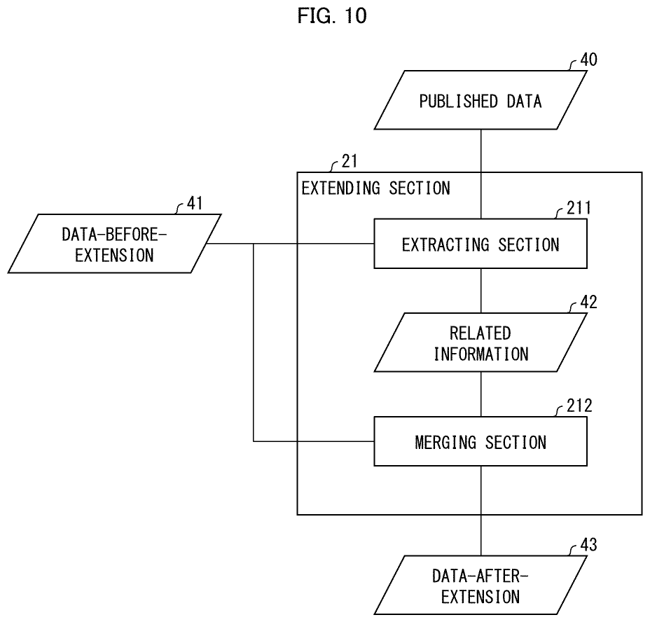

FIG. 10 is a view illustrating an example of a specific configuration of the extending section 21 included in the control section 10 of the information processing apparatus 1. In an example, the extending section 21 in accordance with the present example embodiment extends target data by adding, to the target data, a piece of information relating to the target data among pieces of information included in published data 40. In the following description, the piece of information relating to the target data among the pieces of information included in the published data 40 will be referred to as “related information”. For example, as shown in FIG. 10, the extending section 21 may include an extracting section 211 and a merging section 212. In the present example embodiment, the extracting section 211 is a configuration realizing an extracting means. In the present example embodiment, the merging section 212 is a configuration realizing a merging means.

The extracting section 211 compares the data-before-extension 41, which is the target data having not been extended yet, with the published data 40. Then, the extracting section 211 extracts related information 42, which relates to the data-before-extension 41, from among the pieces of information included in the published data 40.

The merging section 212 merges the related information 42 with the data-before-extension 41, so as to generate the data-after-extension 43.

(Data Structure)

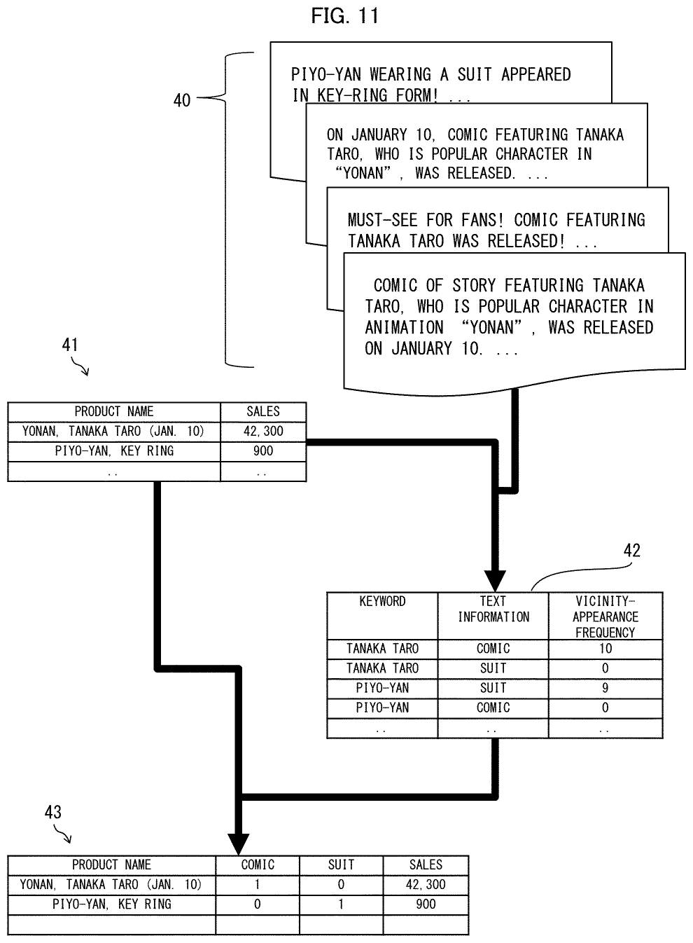

FIG. 11 is a view illustrating an example of a data structure of various data input and output by the extending section 21. Assume that the data obtaining section 23 has obtained published data 40 shown in FIG. 11 from a website of a seller company S on the basis of a URL of the seller company S. In an example, the published data 40 is web page data including a plurality of pieces of text data, as shown in FIG. 11. The published data 40 is input to the extending section 21 by the data obtaining section 23.

Meanwhile, as target data read from the target data DB 111, data-before-extension 41 shown in FIG. 11 is input to the extending section 21. In an example, the target data is sales record information of a buyer company B. Assume that the sales record information in a state of the data-before-extension 41 is constituted by, e.g., two data items “product name” and “sales”, which indicates a sales amount.

The extracting section 211 of the extending section 21 extracts related information 42 from the published data 40. Extracted as the related information 42 may be information which is included in the published data 40 and which appears in the vicinity of a keyword at a frequency exceeding a given value, the keyword being included in the data-before-extension 41. Then, the merging section 212 may merge, as a new data item, the extracted related information 42 with the data-before-extension 41.

Specifically, the extracting section 211 extracts a keyword from the data-before-extension 41. For example, the extracting section 211 may extract, as a keyword, a given morpheme from the data-before-extension 41 according to a given dictionary. The data-before-extension 41 includes, as data items for product items, names of characters, such as “TANAKA Taro” and “Piyo-yan”, appearing in an animation, a video game, or the like. The extracting section 211 may extract such a character name as a keyword.

Meanwhile, the published data 40 includes text information “comic”, which frequently appears in the vicinity of the keyword “TANAKA Taro”. The extracting section 211 can extract, as information relating to the data-before-extension 41, the text information “comic”, which frequently appears in the vicinity of the keyword “TANAKA Taro”. In addition, the extracting section 211 may extract, from the published data 40, text information which frequently appears in the vicinity of a plurality of keywords included in the data-before-extension 41.

Further, the extracting section 211 may calculate, for each set of a keyword included in the data-before-extension 41 and text information included in the published data 40, a vicinity-appearance frequency in the published data 40. The extracting section 211 may output the text information having frequently appeared in the vicinity of the keyword included in the data-before-extension 41 to the merging section 212 as the related information 42. In a result given in the example shown FIG. 11, the text information “comic” has frequently appeared in the vicinity of “TANAKA Taro”, and the text information “suit” has frequently appeared in the vicinity of “Piyo-yan”. For example, each piece of text information may be determined as having frequently appeared in accordance with a vicinity-appearance frequency of not less than 7. On the basis of this result, the extracting section 211 may output, as the related information 42, the pieces of text information “comic” and “suit” to the merging section 212.

The merging section 212 merges, as a new data item of the target data, the related information 42 supplied from the extracting section 211 with the data-before-extension 41. Specifically, the merging section 212 adds, as new data items, the pieces of text information “comic” and “suit” to the data-before-extension 41. Consequently, the target data having been extended, i.e., the data-after-extension 43 has not only the data items “product name” and “sales” but also the data items “comic” and “suit”

Further, as shown in FIG. 11, the merging section 212 may associate, in the data-after-extension 43, (i) determination flag information indicating the presence or absence of frequent appearance determined on the basis of the vicinity-appearance frequency with (ii) a corresponding set of a product name including a keyword and text information added as a new data item. On the basis of the fact that “TANAKA Taro” and “comic”, which constitute a set, have a vicinity-appearance frequency of not less than 7, the merging section 212 associates this set with determination flag information “1”, which means “the presence of frequent appearance”. On the basis of the fact that “TANAKA Taro” and “suit”, which constitute a set, have a vicinity-appearance frequency of less than 7, the merging section 212 associates this set with determination flag information “0”, which means “the absence of frequent appearance”.

(Variation of Extending Section 21)

The extracting section 211 of the extending section 21 extracts related information 42 from the published data 40. Extracted as the related information 42 may be information which is included in the published data 40 and whose similarity to a keyword exceeds a given value, the keyword being included in the data-before-extension 41. Then, the merging section 212 may merge, as a new data item, the extracted related information 42 with the data-before-extension 41.

For example, in a case where the published data 40 includes text information or image information such as “Yonan, TANAKA Jiro” or “Yonan, NAKATA Saburo”, the extracting section 211 may extract these pieces of data as related information 42 having a high similarity to “Yonan, TANAKA Taro” included in the data-before-extension 41.

The merging section 212 may form the related information 42 extracted by the extracting section 211 into the one having the same data item configuration as that of the data-before-extension 41, and may add the formed related information as a record. For example, assume that the data-before-extension 41 is sales record information constituted by two data items “product name” and “sales” and is a database including 100 records on 100 types of animation-related products. Meanwhile, assume that the extracting section 211 has extracted, from the published data 40, sales information on ten other types of animation-related products as related information 42.

In this case, for the ten other types of animation-related products, the merging section 212 may form sales record information constituted by the two data items “product name” and “sales”, and may add the formed information to the data-before-extension 41. Consequently, the data-after-extension 43 is extended into a database including 110 records on 110 types of animation-related products. An increase in the number of samples included in the target data, such as the number of records in the database or the number of rows in the table, leads to output of a significant analysis result.

As described above, the information processing apparatus 1 in accordance with the present example embodiment employs a configuration in which the extending section 21 adds, to target data, information which is included in published data and which relates to the target data.

Therefore, with the information processing apparatus 1 in accordance with the present example embodiment, it is possible to add the related information having a high affinity with the target data having not been extended yet, thereby making it possible to enrich the content of the target data. Consequently, it is possible to attain, in addition to the effects given by the information processing apparatuses 1 in accordance with the foregoing example embodiments, an effect of making it possible to obtain a second analysis result which is more valuable for a buyer. The increase in the value of the second analysis result for the buyer leads to an increase in a market value of the published data, which leads to stimulation of the data distribution market.

Further, the information processing apparatus 1 in accordance with the present example embodiment employs a configuration in which the extending section 21 includes: the extracting section 211 that extracts, from published data, information which appears in the vicinity of a keyword at a frequency exceeding a given value, the keyword being included in the target data; and the merging section 212 that merges the extracted information with the target data as a data item of the target data.

Therefore, with the information processing apparatus 1 in accordance with the present example embodiment, it is possible to add, to the target data, the related information which frequently appears in the vicinity of the keyword included in the target data having not been extended yet, thereby making it possible to enrich the content of the target data. As a result, it is possible to attain an effect of making it possible to further increase a value of a second analysis result for a buyer.

Alternatively, the information processing apparatus 1 in accordance with the present example embodiment employs a configuration in which the extending section 21 includes: the extracting section 211 that extracts, from the published data, information whose similarity to a keyword exceeds a given value, the keyword being included in the target data; and the merging section 212 that merges the extracted information with the target data as a data item of the target data.

Therefore, with the information processing apparatus 1 in accordance with the present example embodiment, it is possible to add, to the target data, the related information which is similar to the keyword included in the target data having not been extended yet, thereby making it possible to enrich the content of the target data. As a result, it is possible to attain an effect of making it possible to further increase a value of a second analysis result for a buyer.

<Estimation of Degree of Value Enhancement>

(Configuration of Estimating Section 21)

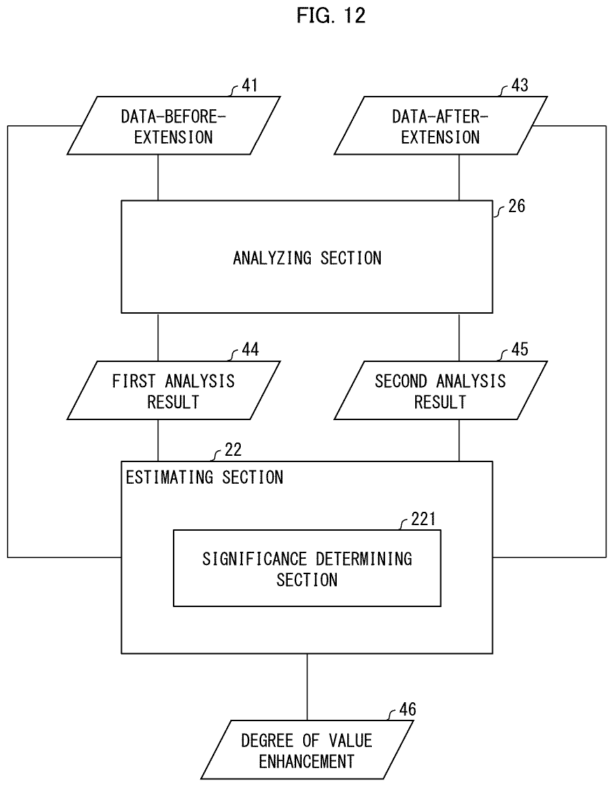

FIG. 12 is a view illustrating an example of a specific configuration of the estimating section 22 included in the control section 10 of the information processing apparatus 1. For example, the estimating section 22 in accordance with the present example embodiment estimates the degree of value enhancement 46 on the basis of at least one of the following differences. That is, the differences are (1) a difference between the data-before-extension 41 and the data-after-extension 43 and (2) a difference between the first analysis result, which is a result of analyzing the data-before-extension 41, and the second analysis result, which is a result of analyzing the data-after-extension 43. Specifically, the estimating section 22 carries out estimation so as to increase the degree of value enhancement 46 as the above difference is increased.

In the present example embodiment, the analyzing section 26 analyzes the target data and outputs an analysis result, which is a result of the analysis. The analyzing section 26 may analyze the data-before-extension 41, and may output a first analysis result 44, which is a result of the analysis. The analyzing section 26 may analyze the data-after-extension 43, and may output a second analysis result 45, which is a result of the analysis.

For example, the analyzing section 26 may be a predicting unit that analyzes target data and outputs a prediction result indicating a given phenomenon. In this case, the first analysis result 44 output from the analyzing section 26 is a first prediction result obtained as a result of analyzing the data-before-extension 41, and the second analysis result 45 is a second prediction result obtained as a result of analyzing the data-after-extension 43.

The estimating section 22 may compare the first prediction result with an actually happened phenomenon to derive a first budget/actual error. The estimating section 22 may compare the second prediction result with an actually happened phenomenon to derive a second budget/actual error. Then, the estimating section 22 estimates a degree of value enhancement of the second analysis result 45 relative to the first analysis result 44 so as to increase the degree of value enhancement as the second budget/actual error is decreased relative to the first budget/actual error. That is, the estimating section 22 carries out estimation so as to increase the degree of value enhancement with an increase in accuracy in the prediction of the second prediction result.

Further, for example, the analyzing section 26 may be a classifier that analyzes target data to determine a given phenomenon and outputs a determination result. In this case, the first analysis result 44 output from the analyzing section 26 is a first determination result obtained as a result of analyzing the data-before-extension 41, and the second analysis result 45 is a second determination result obtained as a result of analyzing the data-after-extension 43.

The estimating section 22 may derive a first correct answer percentage by comparing the first determination result with correct data. The estimating section 22 may derive a second correct answer percentage by comparing the second determination result with correct data. Then, the estimating section 22 estimates a degree of value enhancement of the second analysis result 45 relative to the first analysis result 44 so as to increase the degree of value enhancement as the second correct answer percentage is increased relative to the first correct answer percentage. That is, the estimating section 22 carries out estimation so as to increase the degree of value enhancement with an increase in accuracy in the determination of the second determination result.

For example, the estimating section 22 may increase the degree of value enhancement as an amount of increase in at least one of the number of data items and the number of samples in the data-after-extension 43 is increased as compared to that of the data-before-extension 41. As described above, as at least one of the number of data items and the number of samples in the target data is increased, a significant analysis result is more likely to be obtained.

Alternatively, for example, the analyzing section 26 may be a business intelligence (BI) tool that analyzes target data and outputs, as an analysis result, visualized information which is visually recognizable. In this case, a first analysis result 44 output from the analyzing section 26 is first visualized information obtained as a result of analyzing the data-before-extension 41, and a second analysis result 45 is second visualized information obtained as a result of analyzing the data-after-extension 43.

The estimating section 22 may compare the first visualized information with the second visualized information, and may increase the degree of value enhancement as a significance of the second visualized information is increased. For example, the significance of the visualized information can be determined as high when the visualized information is excellent in the following point(s): the visualized information has excellent browsability; the visualized information is indicated in such a manner as to allow a viewer to acknowledge an important point at a glance; and/or the visualized information showing a result in such a manner as to provide an excellent insight and to support viewer's decision making.

The estimating section 22 may include a significance determining section 221 that receives, as an input value, visualized information and outputs, as an output value, an index value indicating a significance of the visualized information. In the present example embodiment, the significance determining section 221 is a configuration realizing a significance determining means. The estimating section 22 may increase the degree of value enhancement as a significance indicated by the index value output by the significance determining section 221 is increased. For example, the significance determining section 221 may be realized with use of the technique disclosed in Non-Patent Literature 3.

(Variation; Statistical Causal Discovery)

Alternatively, for example, the analyzing section 26 may be a statistical causal discovery section that analyzes target data with use of a statistical causal discovery technology. The analyzing section 26 serving as the statistical causal discovery section is a configuration realizing the statistical causal discovery means in the present example embodiment. The analyzing section 26 receives, as an input value, target data and an objective variable included in the target data, and outputs, as an output value, causal relation data including at least a plurality of keywords included in the target data and information indicating a causal relation between the keywords. The analyzing section 26 serving as the statistical causal discovery section may be realized by, for example, the technique disclosed in Non-Patent Literature 2.

The analyzing section 26 receives, as an input value, data-before-extension 41, and outputs, as an output value, a first analysis result 44 which is first causal relation data. The analyzing section 26 receives, as an input value, data-after-extension 43, and outputs, as an output value, a second analysis result 45 which is second causal relation data. In both of the two analyses, identical keywords in the target data are designated as an objective variable.

The estimating section 22 may increase the degree of value enhancement with an increase of the number of sets of keywords having a causal relation therebetween in the second analysis result 45 relative to that of the first analysis result 44.

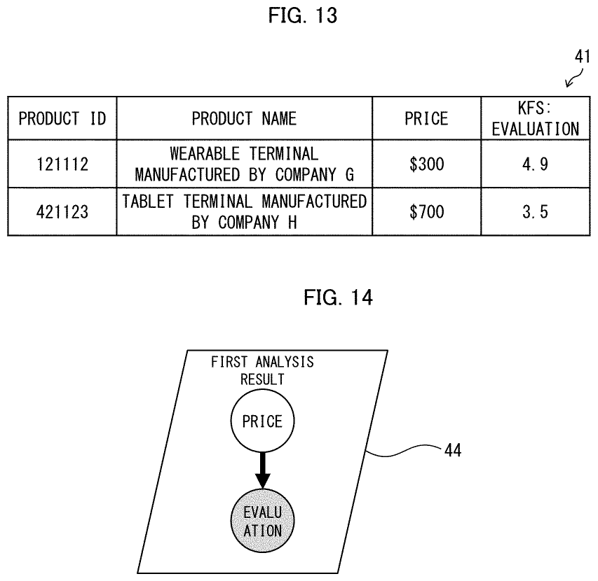

FIG. 13 is a view illustrating an example of a data structure of the data-before-extension 41 in accordance with the present variation. For example, assume that the target data is sales record information of the buyer company B, and is constituted by four data items “product ID”, “product name”, “price”, and “evaluation” while being in a state of the data-before-extension 41. For example, there may be a case where it is known that a key success factor (KSF) among the four data items in the data-before-extension 41 is “evaluation”. In such a case, the “evaluation” and the data-before-extension 41 may be input to the analyzing section 26 as objective variables.

FIG. 14 is a view illustrating an example of a data structure of first causal relation data (first analysis result 44) output by the analyzing section 26 as an output value in response to reception of the data-before-extension 41 shown in FIG. 13 and the objective variable “evaluation” as an input value. As shown in FIG. 14, the causal relation data includes a plurality of keywords extracted from the data-before-extension 41 and information indicating a causal relation between the keywords.

The first analysis result 44 obtained from the data-before-extension 41 shows only a causal relation between a price and evaluation. Thus, it is difficult to say that the first analysis result 44 is significant information valuable for the buyer company B.

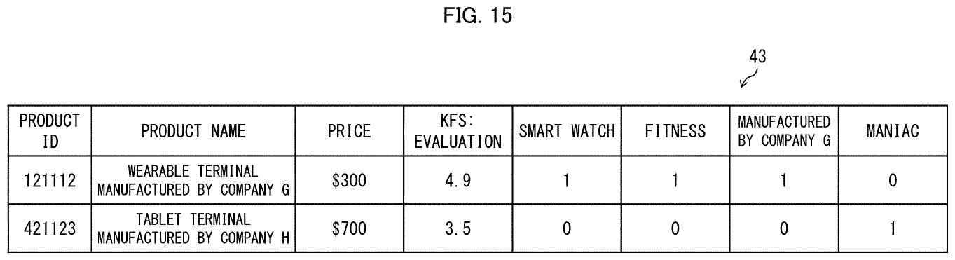

FIG. 15 is a view illustrating an example of a data structure of the data-after-extension 43 in accordance with this variation. The data-after-extension 43 may be obtained by, for example, the extending section 21 adding a new data item to the data-before-extension 41 with use of the published data 40 in the above-described manner. In the example shown in FIG. 15, new data items “smart watch”, “fitness”, “manufactured by Company G”, and “maniac” are added.

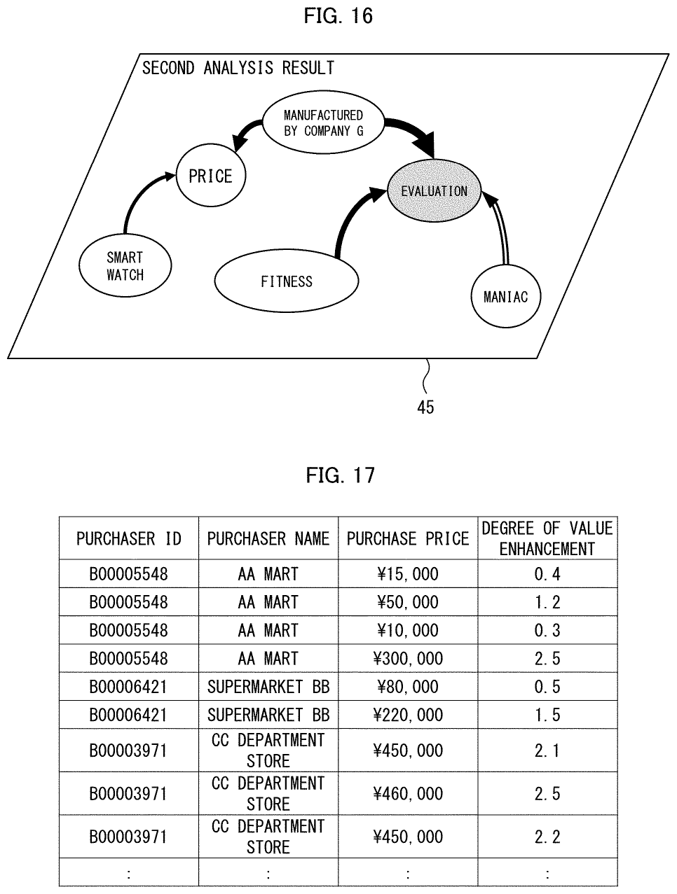

FIG. 16 is a view illustrating an example of a data structure of second causal relation data (second analysis result 45) output by the analyzing section 26 as an output value in response to reception of the data-after-extension 43 shown in FIG. 15 and the objective variable “evaluation” as input values. The information indicating the causal relation may include information indicating the strength of the causal relation, information indicating a direction of the causal relation, information indicating whether the connection therebetween is positive or negative, and the like.

When compared to the first analysis result 44, the second analysis result 45 obtained from the data-after-extension 43 includes a plurality of keywords which are not a price and are determined as being correlated with the evaluation. On the basis of such a second analysis result 45, the buyer company B is more likely to be able to focus on an important factor of a product which may lead to high evaluation or, conversely, a negative factor which may lower the evaluation. It can be said that the second analysis result 45 is more significant information valuable for the buyer company B than the first analysis result 44.

The estimating section 22 carries out estimation by comparing the first analysis result 44 with the second analysis result 45 and increasing the degree of value enhancement of the second analysis result 45 as the number of sets of keywords having a causal relation therebetween is increased.

As described above, the information processing apparatus 1 in accordance with the present example embodiment employs a configuration in which the estimating section 22 increases the degree of value enhancement as a difference is increased, the difference being at least one of (i) a difference between the target data having not been extended yet and the target data having been extended and (ii) a difference between the first analysis result and the second analysis result.

Thus, with the information processing apparatus 1 in accordance with the present example embodiment, it is possible to attain, in addition to the effects given by the information processing apparatuses 1 in accordance with the foregoing example embodiments, an effect of making it possible to quantitatively evaluate a value of published data of a seller from the viewpoint of benefit which is to be brought to a buyer.

Further, in the present example embodiment, the first analysis result may indicate a result of predicting or determining a given phenomenon with use of the target data having not been extended yet, and the second analysis result may indicate a result of predicting or determining the given phenomenon with use of the target data having been extended. In this case, the estimating section 22 employs a configuration to increase the degree of value enhancement with an increase in accuracy in the prediction or determination of the second analysis result.

Therefore, with the information processing apparatus 1 in accordance with the present example embodiment, it is possible to attain an effect of making it possible to quantitatively evaluate a value of published data of a seller from the viewpoint of, as benefit which is to be brought to a buyer, how much the prediction accuracy or determination accuracy is enhanced.

In the information processing apparatus 1 in accordance with the present example embodiment, the estimating section 22 employs a configuration of increasing the degree of value enhancement as an amount of increase in at least one of the number of data items and the number of samples in the target data having been extended is increased as compared to that of the target data having not been extended yet.

Therefore, with the information processing apparatus 1 in accordance with the present example embodiment, it is possible to attain an effect of making it possible to quantitatively estimate a value of published data of a seller from the viewpoint of, as benefit which is to be brought to a buyer, how much an amount of information in target data increases.

Further, in the present example embodiment, the first analysis result may include visualized information which is visually recognizable, the visualized information being obtained by conversion of the target data having not been extended yet; and the second analysis result may include visualized information which is visually recognizable, the visualized information being obtained by conversion of the target data having been extended. In this case, the estimating section 22 employs a configuration that increases the degree of value enhancement as a significance of the visualized information included in the second analysis result is increased.

In the information processing apparatus 1 in accordance with the present example embodiment, the estimating section 22 employs a configuration including the significance determining section 221 that receives, as an input value, the visualized information and outputs, as an output value, an index value indicating significance of the visualized information, wherein the estimating section 22 increases the degree of value enhancement as a significance indicated by the index value is increased.

Therefore, with the information processing apparatus 1 in accordance with the present example embodiment, it is possible to attain an effect of making it possible to quantitatively estimate a value of published data of a seller from the viewpoint of, as benefit which is to be brought to a buyer, how attractive an analysis result obtained from target data is to the buyer.

The information processing apparatus 1 in accordance with the present example embodiment may further include the analyzing section 26 that employs the statistical causal discovery technology that receives, as an input value, target data and an objective variable included in the target data and output, as an output value, a plurality of keywords included in the target data and information indicating a causal relation between the keywords. The estimating section 22 of the information processing apparatus 1 configured as such employs a configuration of increasing the degree of value enhancement as the number of sets of keywords having a causal relation therebetween included in the second analysis result is increased as compared to that in the first analysis result, the first analysis result being output as the output value by the analyzing section 26 in response to reception of, as an input value, the target data having not been extended yet, the second analysis result being output as the output value by the analyzing section 26 in response to reception of, as an input value, the target data having been extended.

Therefore, with the information processing apparatus 1 in accordance with the present example embodiment, it is possible to attain an effect of making it possible to quantitatively estimate a value of published data of a seller from the viewpoint of, as benefit which is to be brought to a buyer, how much important element correlated with an objective variable is included in causal relation data obtained from target data.

<Calculation of Sales Price>

The control section 10 of the information processing apparatus 1 may further include a price calculating section 25 that calculates, in accordance with the degree of value enhancement estimated by the estimating section 22, a sales price of the published data 40 of the seller. In the present example embodiment, the price calculating section 25 is a configuration realizing a price calculating means.

The price calculating section 25 determines the sales price such that the sales price becomes higher in proportional to the estimated degree of value enhancement, for example. For example, the price calculating section 25 may calculate, as the sales price, an analysis service utilization fee (FIG. 3) that the buyer company B pays to the information processing apparatus 1 or a published data usage fee that the seller company S receives from the information processing apparatus 1. Alternatively, the price calculating section 25 may calculate both the analysis service utilization fee and the published data usage fee. In this case, when the sales price is to be presented to the buyer company B, the output control section 24 may employ the analysis service utilization fee. Meanwhile, when the sales price is to be presented to the seller company S, the output control section 24 may employ the published data usage fee.

The price calculating section 25 may refer to purchase history information in which (a) a purchase price at which the buyer company B purchased the published data 40 and (b) the degree of value enhancement 46 given on the basis of the published data 40 are associated with each other. Then, the price calculating section 25 may modify the sales price to increase the sales price as the purchase price is increased.

(Purchase History Information 113)

FIG. 17 is a view illustrating an example of a data structure of the purchase history information 113 stored in the storage section 11. For example, the purchase history information 113 may include four data items, i.e., a purchaser ID, a purchaser name, a purchase price, and a degree of value enhancement. The purchase history information 113 may further include non-illustrated four data items, i.e., a seller ID, a seller name, a URL, and a purchase date, as needed.

The purchaser ID indicates identification information with which the buyer company B is uniquely identified. The purchaser name indicates a name of the buyer company B. The purchase price indicates a purchase price at which the buyer company B purchased the published data 40. The degree of value enhancement indicates a degree of value enhancement of a second analysis result 45 obtained as a result of analyzing target data with use of the published data 40 having been purchased.

The seller ID indicates identification information with which the seller company S, which possesses the published data 40 purchased by the buyer company B, is uniquely identified. The seller name indicates a name of the seller company S. The URL indicates information specifying the published data 40 (web page data) having been purchased. The purchase date indicates date and time of purchase of the published data 40.

The price calculating section 25 can modify, on the basis of the purchase history information 113, the sales price calculated on the basis of the degree of value enhancement. For example, in a case where a purchase price with respect to the degree of value enhancement relating to a certain buyer company B is higher than those of the other buyers, the price calculating section 25 may modify the sales price presented to the certain buyer company B to increase the sales price. For another example, in a case where a purchase price with respect to the degree of value enhancement at which purchase price the published data 40 of a certain seller company S was purchased is lower than those of the other sellers, the price calculating section 25 may modify the purchase price of the published data 40 of the certain seller company S to decrease the sales price.

As described above, the information processing apparatus 1 in accordance with the present example embodiment employs a configuration further including the price calculating section 25 that calculates a sales price of the published data of the seller in accordance with the degree of value enhancement estimated by the estimating section 22.

Thus, with the information processing apparatus 1 in accordance with the present example embodiment, it is possible to attain, in addition to the effects given by the information processing apparatuses 1 in accordance with the foregoing example embodiments, an effect of making it possible to set a reasonable price on the basis of the degree of value enhancement.

In the information processing apparatus 1 in accordance with the present example embodiment, the price calculating section 25 employs a configuration that refers to the purchase history information 113 in which (i) a purchase price at which the buyer purchased the published data and (ii) the degree of value enhancement given on the basis of the published data are associated with each other and modifies the sales price to increase the sales price as the purchase price is increased.

Thus, with the information processing apparatus 1 in accordance with the present example embodiment, it is possible to attain, in addition to the effects given by the information processing apparatuses 1 in accordance with the foregoing example embodiments, an effect of making it possible to set a reasonable price on the basis of the degree of value enhancement and the buyer's demand.

<Flow of Process>

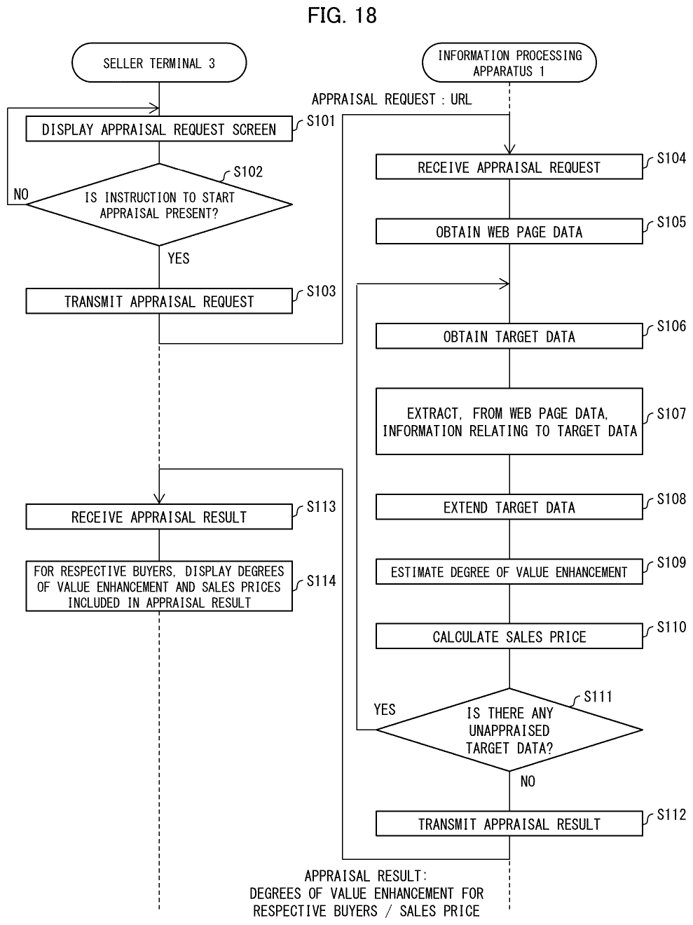

FIG. 18 is a sequence diagram illustrating an example of an information processing method in accordance with the present example embodiment, which is executed in the data distribution system 100. In an example, the information processing method shown in FIG. 18 is a method for evaluating, i.e., appraising a market value of published data in order to distribute published data of a seller by the data distribution method in accordance with the second example embodiment. Note that the information processing method of the present disclosure is not limited to the example shown in FIG. 18, and is applicable to a method for searching for published data that increases a value of an analysis result of analysis carried out on target data of a buyer.

In relation to the example shown in FIG. 18, the following will describe a case where the seller terminal 3 of the seller company is caused to execute inputting of an instruction to start appraisal and displaying of an appraisal result. However, the information processing method of the present disclosure is not limited to such an example. The information processing method of the present disclosure is applicable to a case where the information processing apparatus 1 of the service provider is caused to execute all the steps including inputting of the instruction to start appraisal and displaying of the appraisal result. In the former case, the “user” means an operator of the seller company who operates the seller terminal 3. Meanwhile, in the latter case, the “user” means an operator of the service provider who operates the information processing apparatus 1.

In step S101, the seller terminal 3 causes a display section of the seller terminal 3 to display the appraisal request screen 50 shown in FIG. 6. For example, the output control section 24 of the information processing apparatus 1 may accept, from the seller terminal 3, a message requesting the appraisal request screen 50, and may return information relating to the appraisal request screen 50 so as to cause the display section of the seller terminal 3 to display the appraisal request screen 50.

In step S102, the seller terminal 3 accepts, from the user, an input operation for instructing to start appraisal. For example, the seller terminal 3 may accept the instruction to start appraisal in response to pressing of the button 61 in a state where a URL of published data is inputted in the region 60 of the appraisal request screen 50. Upon reception of the instruction to start appraisal, the seller terminal 3 advances to S103 through “YES” of S102.

In step S103, the seller terminal 3 transmits an appraisal request to the information processing apparatus 1. The seller terminal 3 transmits, to the information processing apparatus 1, the appraisal request including at least the URL input in the region 60. The appraisal request may further include ID of the seller company S with which ID the seller company S possessing the published data designated by the URL is identified.

In step S104, the data obtaining section 23 of the information processing apparatus 1 receives the appraisal request from the seller terminal 3.

In step S105, the data obtaining section 23 obtains web page data of a website indicated by the URL included in the appraisal request thus received.

In step S106, the data obtaining section 23 obtains target data from target data DB 111 stored in the storage section 11 in advance. The data obtaining section 23 may extract only target data of the buyer company B which meets a given condition so that the target data matches the seller company S which is a requesting entity. Here, the data obtaining section 23 may obtain a plurality of pieces of candidate target data that are to match the published data that is requested to be appraised. In a case where the data obtaining section 23 obtains the plurality of pieces of candidate target data, the data obtaining section 23 reads out, from among the candidates, a single piece of target data which is to be subjected to a process of estimating a degree of value enhancement later. A group of processes S106 to S111 will be repeated until the number of repetition reaches the number of pieces of obtained target data.

In step S107, the extending section 21 extracts, from the information included in the web page data, related information relating to the target data.

In step S108, the extending section 21 extends the target data on the basis of the related information thus extracted.

In step S109, the estimating section 22 estimates a degree of value enhancement of a second analysis result obtained as a result of carrying out analysis with use of the data-after-extension.

In step S110, the price calculating section 25 calculates, on the basis of the degree of value enhancement thus estimated, a sales price at which the seller company S which is a requesting entity sells the above-described web page data to the buyer company B possessing the above-described target data.

In step S11, the data obtaining section 23 determines whether or not, among the plurality of pieces of target data obtained in S106, any piece of target data having not been subjected to estimation of a degree of value enhancement and calculation of a sales price is left. If there is a piece of target data having not been subjected to appraisal yet, the process is returned to S106 through YES of S111, and the processes in S106 and subsequent steps are carried out again. If all the pieces of target data obtained in S106 have undergone appraisal, the process advances to S112 through NO in S11.

In step S112, the output control section 24 transmits an appraisal result to the seller terminal 3 which is a requesting entity. For example, the output control section 24 transmits, to the seller terminal 3, the appraisal result including candidate buyer companies B and degrees of value enhancement which are to be brought to the buyer companies B. The output control section 24 may further incorporate, into the appraisal result, sales prices calculated on the basis of the degrees of value enhancement.

In step S113, the seller terminal 3 receives the appraisal result from the information processing apparatus 1.

In step S114, the seller terminal 3 causes the display section of the seller terminal 3 to display, for respective buyer companies B, degrees of value enhancement and sales prices included in the appraisal result thus received. For example, the seller terminal 3 may cause the display section to display the appraisal result screen 51, shown in FIG. 7, in which the above-described appraisal result has been determined.

Software Implementation Example

Part of or the whole of functions of the information processing apparatus 1 can be realized by hardware such as an integrated circuit (IC chip) or can be alternatively realized by software.

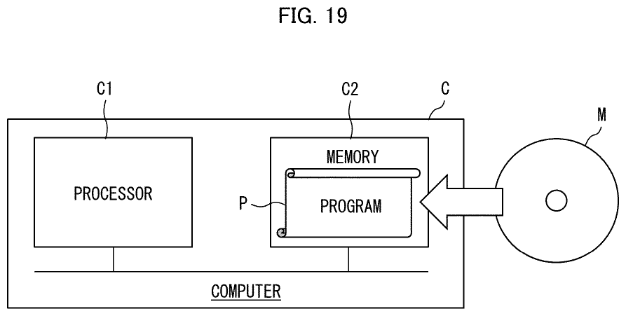

In the latter case, the information processing apparatus 1 is realized by, for example, a computer that executes instructions of a program that is software realizing the foregoing functions. FIG. 19 shows an example of such a computer (hereinafter, referred to as a “computer C”). The computer C includes at least one processor C1 and at least one memory C2. The memory C2 has a program P stored therein, the program P causing the computer C to operate as the information processing apparatus 1. In the computer C, the processor C1 reads and executes the program P from the memory C2, thereby realizing the functions of the information processing apparatus 1.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination of any of them. The memory C2 may be, for example, a flash memory, hard disk drive (HDD), solid state drive (SSD), or a combination of any of them.

The computer C may further include a random access memory (RAM) in which the program P is loaded when executed and various data is temporarily stored. In addition, the computer C may further include a communication interface via which the computer C transmits/receives data to/from another device. The computer C may further include an input-output interface via which the computer C is connected to an input-output device such as a keyboard, a mouse, a display, and/or a printer.

The program P can be stored in a non-transitory, tangible storage medium M capable of being read by the computer C. Examples of the storage medium M encompass a tape, a disk, a card, a semiconductor memory, and a programmable logic circuit. The computer C can obtain the program P via the storage medium M. Alternatively, the program P can be transmitted via a transmission medium. Examples of such a transmission medium encompass a communication network and a broadcast wave. The computer C can also obtain the program P via the transmission medium.

[Supplementary Remarks 1]

The present invention is not limited to the foregoing example embodiments, but can be altered by a skilled person in the art within the scope of the claims. The present invention also encompasses, in its technical scope, any embodiment derived by combining technical means disclosed in differing embodiments.

[Supplementary Remarks 2]

Some or all of the above example embodiments can be described as below. Note, however, that the present invention is not limited to example aspects described below.

(Supplementary Note 1)

An information processing apparatus including: an extending means that extends, with use of published data which is possessed by at least one seller and which has been already published or is scheduled to be published, target data which is possessed by at least one buyer and which is a subject to be analyzed; and an estimating means that estimates a degree of value enhancement of a second analysis result relative to a first analysis result, the first analysis result being a result of analyzing the target data having not been extended yet, the second analysis result being a result of analyzing the target data having been extended.

(Supplementary Note 2)

The information processing apparatus described in Supplementary Note 1, wherein: the published data is web page data constituting a website of the at least one seller.

(Supplementary Note 3)

The information processing apparatus described in Supplementary Note 2, further including: a data obtaining means that obtains the web page data on a basis of a Uniform Resource Locator designated by a user; and an output control means that outputs, for each of the at least one buyer possessing the target data, the degree of value enhancement of the second analysis result obtained from the target data having been extended with use of the web page data thus obtained.

(Supplementary Note 4)

The information processing apparatus described in Supplementary Note 2 or 3, further including: a data obtaining means that obtains the target data designated by the user; and an output control means that outputs, for each of the at least one seller possessing the web page data, the degree of value enhancement of the second analysis result obtained as a result of extending the obtained target data with use of the web page data.

(Supplementary Note 5)

The information processing apparatus described in any one of Supplementary Notes 1 to 4, wherein: the extending means adds, to the target data, information which is included in the published data and which relates to the target data.

(Supplementary Note 6)

The information processing apparatus described in Supplementary Note 5, wherein: the extending means includes: an extracting means that extracts, from the published data, information which appears in vicinity of a keyword at a frequency exceeding a given value, the keyword being included in the target data; and a merging means that merges the extracted information with the target data as a data item of the target data.

(Supplementary Note 7)

The information processing apparatus described in Supplementary Note 5, wherein: the extending means includes: an extracting means that extracts, from the published data, information whose similarity to a keyword exceeds a given value, the keyword being included in the target data; and a merging means that merges the extracted information with the target data as a data item of the data item.

(Supplementary Note 8)

The information processing apparatus described in any one of Supplementary Notes 1 to 7, wherein: the estimating means increases the degree of value enhancement as a difference increases, the difference being at least one of a difference between the target data having not been extended yet and the target data having been extended and a difference between the first analysis result and the second analysis result.

(Supplementary Note 9)

The information processing apparatus described in Supplementary Note 8, wherein: the first analysis result indicates a result of predicting or determining a given phenomenon with use of the target data having not been extended yet, and the second analysis result indicates a result of predicting or determining the given phenomenon with use of the target data having been extended, and the estimating means increases the degree of value enhancement with an increase in accuracy in the prediction or determination of the second analysis result.

(Supplementary Note 10)

The information processing apparatus described in Supplementary Note 8, wherein: the estimating means increases the degree of value enhancement as an amount of increase in at least one of the number of data items and the number of samples in the target data having been extended is increased as compared to that of the target data having not been extended yet.

(Supplementary Note 11)

The information processing apparatus described in Supplementary Note 8, wherein: the first analysis result includes visualized information which is visually recognizable, the visualized information being obtained by conversion of the target data having not been extended yet, and the second analysis result includes visualized information which is visually recognizable, the visualized information being obtained by conversion of the target data having been extended; and the estimating means increases the degree of value enhancement as a significance of the visualized information included in the second analysis result is increased.

(Supplementary Note 12)

The information processing apparatus described in Supplementary Note 11, wherein: the estimating means includes: a significance determining means that (a) receives, as an input value, the visualized information and (b) outputs, as an output value, an index value indicating a significance of the visualized information; and the estimating means increases the degree of value enhancement as a significance indicated by the index value is increased.

(Supplementary Note 13)

The information processing apparatus described in Supplementary Note 8, further including: a statistical causal discovery means that (a) receives, as input values, the target data and an objective variable included in the target data, and (b) outputs, as output values, a plurality of keywords included in the target data and information indicating a causal relation between the plurality of keywords, wherein the estimating means increases the degree of value enhancement as the number of sets of keywords having a causal relation therebetween included in the second analysis result is increased as compared to that in the first analysis result, the first analysis result being output as the output value by the statistical causal discovery means in response to reception of, as an input value, the target data having not been extended yet, the second analysis result being output as the output value by the statistical causal discovery means in response to reception of, as an input value, the target data having been extended.

(Supplementary Note 14)

The information processing apparatus described in any one of Supplementary Notes 1 to 13, further including: a price calculating means that calculates a sales price of the published data of the at least one seller in accordance with the degree of value enhancement estimated by the estimating means.

(Supplementary Note 15)

The information processing apparatus described in Supplementary Note 14, wherein: the price calculating means refers to purchase history information in which (a) a purchase price at which the at least one buyer purchased the published data and (b) the degree of value enhancement given on the basis of the published data are associated with each other, and the price calculating means modifies the sales price so as to increase the sales price as the purchase price is increased.

(Supplementary Note 16)

A data distribution method including: at least one processor determining, on a basis of benefit which is to be brought to a buyer when target data which is possessed by the buyer and which is a subject to be analyzed is extended and analyzed with use of published data which is possessed by a seller and which has been already published or is scheduled to be published, a sales price of a service that analyzes the target data having been extended; providing, in exchange for a reward corresponding to the sales price, the buyer with analysis result data which is a result of analyzing the target data having been extended with use of the published data; and paying, in exchange for use of the published data, a reward to the seller, the reward corresponding to a part of the sales price.

(Supplementary Note 17)

The data distribution method described in Supplementary Note 16, wherein: the published data is web page data constituting a website of the seller.

(Supplementary Note 18)

An information processing method including: at least one processor extending, with use of published data which is possessed by a seller and which has been already published or is scheduled to be published, target data which is possessed by a buyer and which is a subject to be analyzed; and at least one processor estimating a degree of value enhancement of a second analysis result relative to a first analysis result, the first analysis result being a result of analyzing the target data having not been extended yet, the second analysis result being a result of analyzing the target data having been extended.

(Supplementary Note 19)

A control program causing a computer to function as: an extending means that extends, with use of published data which is possessed by a seller and which has been already published or is scheduled to be published, target data which is possessed by a buyer and which is a subject to be analyzed; and an estimating means that estimates a degree of value enhancement of a second analysis result relative to a first analysis result, the first analysis result being a result of analyzing the target data having not been extended yet, the second analysis result being a result of analyzing the target data having been extended.

In displaying candidate buyers or candidate sellers together with the degrees of value enhancement, the output control means may control the display section such that the candidates are indicated in a descending order of a similarity between target data of a buyer and published data of a seller.

In displaying candidate buyers or candidate sellers together with the degrees of value enhancement, the output control means may control the display section such that the candidates are indicated in a descending order of the degree of value enhancement.

In displaying candidate buyers or candidate sellers together with the degrees of value enhancement, the output control means may control the display section such that the candidates are indicated in a descending order of the sales price.

In causing the display section to display candidate buyers together with the degrees of value enhancement, the output control means may control the display section such that the candidates are indicated in a descending order of price at which the candidate purchased published data or in a descending order of the number of times that the candidate purchased published data.

In causing the display section to display candidate sellers together with the degrees of value enhancement, the output control means may control the display section such that the candidates are indicated in a descending order of price at which published data of the candidate was sold in the past or in a descending order of the number of times that the published data was sold.

[Supplementary Remarks 3]

Some or all of the above example embodiments can alternatively be described as below.

An information processing apparatus including at least one processor, the at least one processor executing: an extending process of extending, with use of published data which is possessed by a seller and which has been published or is scheduled to be published, target data which is possessed by a buyer and which is a subject to be analyzed; and an estimating process of estimating a degree of value enhancement of a second analysis result relative to a first analysis result, the first analysis result being a result of analyzing the target data having not been extended yet, the second analysis result being a result of analyzing the target data having been already extended.

Note that the information processing apparatus may further include a memory. The memory may have a program stored therein, the program causing the processor to execute the extending process and the estimating process. Further, this program may be stored in a computer-readable, non-transitory, tangible storage medium.

### REFERENCE SIGNS LIST

1: information processing apparatus
2: buyer terminal
3: seller terminal
10: control section
11: storage section
12: operating section
13: communication section
14: display section
21: extending section (extending means)
22: estimating section (estimating means)
23: data obtaining section (data obtaining means)
24: output control section (output control means)
25: price calculating section (price calculating means)
26: analyzing section (statistical causal discovery means)
40: published data (web page data)
41: data-before-extension
42: related information
43: data-after-extension
44: first analysis result
45: second analysis result
46: degree of value enhancement
50: appraisal request screen
51: appraisal result screen
52: search request screen
53: search result screen
100: data distribution system
111: target data DB
112: published data DB
113: purchase history information
211: extracting section (extracting means)
212: merging section (merging means)
221: significance determining section (significance determining means)

What is claimed is:

1. An information processing apparatus at least one processor, the at least one processor executing:
an extending process of extending, with use of published data which is possessed by at least one seller and which has been already published or is scheduled to be published, target data which is possessed by at least one buyer and which is a subject to be analyzed; and
an estimating process of estimating a degree of value enhancement of a second analysis result relative to a first analysis result, the first analysis result being a result of analyzing the target data having not been extended yet, the second analysis result being a result of analyzing the target data having been extended.

2. The information processing apparatus according to claim 1, wherein:
the published data is web page data constituting a website of the at least one seller.

3. The information processing apparatus according to claim 2, wherein the at least one processor further executes:
a data obtaining process of obtaining the web page data on a basis of a Uniform Resource Locator designated by a user; and
an output control process of outputting, for each of the at least one buyer possessing the target data, the degree of value enhancement of the second analysis result obtained from the target data having been extended with use of the web page data thus obtained.

4. The information processing apparatus according to claim 2, wherein the at least one processor further executes:
a data obtaining process of obtaining the target data designated by the user; and
an output control process of outputting, for each of the at least one seller possessing the web page data, the degree of value enhancement of the second analysis result obtained as a result of extending the obtained target data with use of the web page data.

5. The information processing apparatus according to claim 1, wherein:
in the extending process, the at least one processor adds, to the target data, information which is included in the published data and which relates to the target data.

6. The information processing apparatus according to claim 5, wherein:
the extending process includes:
an extracting process of extracting, from the published data, information which appears in vicinity of a keyword at a frequency exceeding a given value, the keyword being included in the target data; and
a merging process of merging the extracted information with the target data as a data item of the target data.

7. The information processing apparatus according to claim 5, wherein:
the extending process includes:
an extracting process of extracting, from the published data, information whose similarity to a keyword exceeds a given value, the keyword being included in the target data; and
a merging process of merging the extracted information with the target data as a data item of the data item.

8. The information processing apparatus according to claim 1, wherein:
in the estimating process, the at least one processor increases the degree of value enhancement as a difference increases,
the difference being at least one of
a difference between the target data having not been extended yet and the target data having been extended and
a difference between the first analysis result and the second analysis result.

9. The information processing apparatus according to claim 8, wherein:
the first analysis result indicates a result of predicting or determining a given phenomenon with use of the target data having not been extended yet, and the second analysis result indicates a result of predicting or determining the given phenomenon with use of the target data having been extended, and
in the estimating process, the at least one processor increases the degree of value enhancement with an increase in accuracy in the prediction or determination of the second analysis result.

10. The information processing apparatus according to claim 8, wherein:
in the estimating process, the at least one processor increases the degree of value enhancement as an amount of increase in at least one of the number of data items and the number of samples in the target data having been extended is increased as compared to that of the target data having not been extended yet.

11. The information processing apparatus according to claim 8, wherein:
the first analysis result includes visualized information which is visually recognizable, the visualized information being obtained by conversion of the target data having not been extended yet, and the second analysis result includes visualized information which is visually recognizable, the visualized information being obtained by conversion of the target data having been extended; and
in the estimating process, the at least one processor increases the degree of value enhancement as a significance of the visualized information included in the second analysis result is increased.

12. The information processing apparatus according to claim 11, wherein:
the extending process includes:
a significance determining process of (a) receiving, as an input value, the visualized information and (b) outputting, as an output value, an index value indicating a significance of the visualized information; and
in the estimating process, the at least one processor increases the degree of value enhancement as a significance indicated by the index value is increased.

13. The information processing apparatus according to claim 8, wherein the at least one processor further executes:
a statistical causal discovery process of (a) receiving, as input values, the target data and an objective variable included in the target data, and (b) outputting, as output values, a plurality of keywords included in the target data and information indicating a causal relation between the plurality of keywords, wherein
in the estimating process, the at least one processor increases the degree of value enhancement as the number of sets of keywords having a causal relation therebetween included in the second analysis result is increased as compared to that in the first analysis result, the first analysis result being output as the output value by the statistical causal discovery process in response to reception of, as an input value, the target data having not been extended yet, the second analysis result being output as the output value by the statistical causal discovery process in response to reception of, as an input value, the target data having been extended.

14. The information processing apparatus according to claim 1, wherein the at least one processor further executes:
a price calculating process of calculating a sales price of the published data of the at least one seller in accordance with the degree of value enhancement estimated by the estimating process.

15. The information processing apparatus according to claim 14, wherein:
in the price calculating process,
the at least one processor refers to purchase history information in which (a) a purchase price at which the at least one buyer purchased the published data and (b) the degree of value enhancement given on the basis of the published data are associated with each other, and
the at least one processor modifies the sales price so as to increase the sales price as the purchase price is increased.

16. A data distribution method comprising:
at least one processor determining, on a basis of benefit which is to be brought to a buyer when target data which is possessed by the buyer and which is a subject to be analyzed is extended and analyzed with use of published data which is possessed by a seller and which has been already published or is scheduled to be published, a sales price of a service that analyzes the target data having been extended;
providing, in exchange for a reward corresponding to the sales price, the buyer with analysis result data which is a result of analyzing the target data having been extended with use of the published data; and
paying, in exchange for use of the published data, a reward to the seller, the reward corresponding to a part of the sales price.

17. The data distribution method according to claim 16, wherein:
the published data is web page data constituting a website of the seller.

18. An information processing method comprising:
at least one processor extending, with use of published data which is possessed by a seller and which has been already published or is scheduled to be published, target data which is possessed by a buyer and which is a subject to be analyzed; and
at least one processor estimating a degree of value enhancement of a second analysis result relative to a first analysis result, the first analysis result being a result of analyzing the target data having not been extended yet, the second analysis result being a result of analyzing the target data having been extended.

19. A computer-readable, non-transitory storage medium in which a control program is stored, the control program causing a computer to function as an information processing apparatus recited in claim 1,
the control program causing the computer to execute the extending process and the estimating process.
